(19) United States
(12) Patent Application Publication
(10) Pub. No.: US 2024/0210803 A1
(43) Pub. Date: Jun. 27, 2024

(54) STAND AND ADAPTER

(71) Applicant: SEIKO EPSON CORPORATION, Tokyo (JP)

(72) Inventors: Yusaku TAKAMINE, Azumino-shi (JP); Yoshitsugu AKUTAGAWA, Azumino-shi (JP); Kosuke TABAYASHI, Azumino-shi (JP)

(73) Assignee: SEIKO EPSON CORPORATION, Tokyo (JP)

(21) Appl. No.: 18/390,500

(22) Filed: Dec. 20, 2023

(30) Foreign Application Priority Data
Dec. 21, 2022 (JP) 2022-204116

(51) Int. Cl. G03B 21/14; A47B 21/06; F16M 13/02

(52) U.S. Cl. CPC G03B 21/145; A47B 21/06; F16M 13/027; A47B 2021/066

(57) ABSTRACT

A stand includes a placement table on which a projector that project image light is placed, a leg that supports the placement table, a power supplier that supplies the projector with power for driving the projector, and a first elastic part disposed between the placement table and the projector.

The present application is based on, and claims priority from JP Application Serial Number 2022-204116, filed Dec. 21, 2022, the disclosure of which is hereby incorporated by reference herein in its entirety.

### BACKGROUND

### 1. Technical Field

The present disclosure relates to a stand and an adapter.

### 2. Related Art

JP A-2005-121918 discloses an angle adjustment table apparatus that allows a projector that projects image light to be placed on a swingable frame that shakes like head shaking. The projector is placed on and in contact with a frame.

JP A-2005-121918 is an example of the related art.

The technology described in JP A-2005-121918, however, has a problem of deterioration of visibility that occurs when the frame vibrates, and the vibration of the frame is transmitted directly to the projector, causing a large amount of swing motion of the projected image light.

### SUMMARY

A stand includes a placement table on which a projector that projects image light is placed, a leg that supports the placement table, a power supplier that supplies the projector with power for driving the projector, and an elastic part disposed between the placement table and the projector.

An adapter includes a first terminal attachable to and detachable from an electric contact provided at a wall and the electric contact provided at a stand, a second terminal via which power is supplied via the first terminal to a projector that projects image light, the second terminal coupled to the projector, an extension extending from the second terminal along an installation surface of the projector; and an elastic part disposed between the extension and the projector.

### BRIEF DESCRIPTION OF THE DRAWINGS

FIG. 1 is a cross-sectional view showing the configuration of a first projection unit that is an example of a projection unit.

FIG. 2 is a cross-sectional view showing the configuration of a second projection unit that is another example of the projection unit.

FIG. 3 is a side view showing the configuration of an adapter.

FIG. 4 is a cross-sectional perspective view showing the configuration of the adapter.

FIG. 5 is a perspective view showing the configuration of the adapter.

FIG. 6 is a plan view showing the configuration of the adapter.

FIG. 7 is a cross-sectional view showing an example of the coupling between the adapter and a projector.

FIG. 8 is a cross-sectional view showing another example of the coupling between the adapter and the projector.

FIG. 9 is a cross-sectional perspective view showing an example of the coupling between the adapter and the projector according to a variation.

FIG. 10 is an enlarged view of the portion within the imaginary line shown in FIG. 9.

FIG. 11 is a perspective view showing the configuration of the adapter according to another variation.

FIG. 12 is a perspective view showing the configuration of the adapter according to another variation.

FIG. 13 is a cross-sectional view showing the configuration of the adapter according to another variation.

FIG. 14 is a cross-sectional view showing the configuration of the adapter according to the variation.

FIG. 15 is a cross-sectional view showing the configuration of the adapter according to another variation.

FIG. 16 is a cross-sectional view showing the configuration of the adapter according to another variation.

### DESCRIPTION OF EMBODIMENTS

In the following drawings, three axes perpendicular to one another are called an axis X, an axis Y, and an axis Z in the description. The direction along the axis X is a “direction X”, the direction along the axis Y is a “direction Y”, and the direction along the axis Z is a “direction Z”, with the direction toward the end indicated by the arrow being the direction toward the positive end thereof, the opposite direction of the direction toward the positive end thereof being the direction toward the negative end thereof. The direction Z toward the positive end thereof may be referred to as “upper”, “upward”, or a “front side”, the direction Z toward the negative end thereof may be referred to as “lower”, “downward”, or a “rear side”, and the views in the directions Z toward the positive and negative ends are referred to as a plan or planar view. The description below will be made with a surface facing the positive end of the direction Z referred to as an “upper surface” or a “front surface”, and a surface facing the negative end of the direction Z, which is the surface opposite from the surface facing the positive end of the direction Z, referred to as a “lower surface” or a “rear surface”.

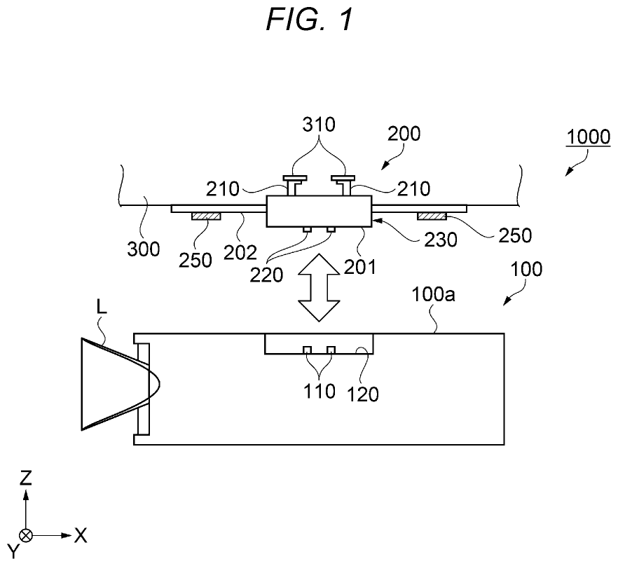

The configuration of a first projection unit 1000, which is an example of a projection unit, will first be described with reference to FIG. 1.

The first projection unit 1000 includes a projector 100 and an adapter 200, which is caused to engage with the projector 100, as shown in FIG. 1.

The projector 100 of the first projection unit 1000 is installed at a ceiling 300 as a wall, and projects image light L from the side facing the ceiling 300, for example, onto a screen. The projector 100 can be installed at the ceiling hook on ceiling 300 via the adapter 200 with power supplied from the ceiling hook ceiling 300 to the projector 100.

The adapter 200 includes first terminals 210, which are attachable to and detachable from electric contacts 310 as a power supplier provided at the ceiling 300, and second terminals 220, via which power for driving the projector 100 is supplied to the projector 100 via the first terminals 210. The second terminals 220 are electrically coupled to third terminals 110 provided at the projector 100. The first terminals 210 function, for example, as ceiling hooks.

The projector 100 is provided with a recess 120 in an upper portion of an enclosure 100a. The third terminals 110, via which power is supplied from the adapter 200, are disposed in the recess 120. Since the third terminals 110 are disposed in the recess 120 as described above, the enclosure 100a can hide the third terminals 110, which are electric contacts as the power supplier of the projector 100, so that the exterior appearance of the projector 100 can be improved.

A lower portion of the adapter 200 has a protrusion 230 as a coupler. The protrusion 230 is provided with the first terminals 210 and the second terminals 220, which are electric contacts as the power supplier. The protrusion 230 is sized to be fitted into the recess 120 provided in the projector 100. That is, the size of the protrusion 230 in the direction X toward the positive end thereof is smaller than the radial size of the recess in the direction X toward the positive end thereof. Since the projector 100 is provided with the recess 120, and the adapter 200 is provided with the protrusion 230, as described above, the protrusion 230 of the adapter 200 can be fitted into the recess 120 of the projector 100, so that the projector 100 can be readily coupled to the adapter 200 (see FIG. 7).

The adapter 200 and the projector 100 are fixed to each other, for example, by using a fixing method using a screw structure or any other structure. Note that the fixing method may not necessarily use a screw structure or any other structure, and the adapter 200 and the projector 100 may be fixed to each other by using any other method that allows the two components are attachable to and detachable from each other.

The adapter 200 includes a central section 201 including the protrusion 230 and an extension 202 extending outward from the central section 201 along the enclosure 100a of the projector 100. An elastic part 250 is disposed at the extension 202 at the side facing the projector 100. The elastic part 250 is made, for example, of rubber or sponge.

Since the elastic part 250 is disposed between the combination of the ceiling 300 and the extension 202 of the adapter 200 and the projector 100, even when the ceiling 300 vibrates, the elastic part 250 can suppress the vibration, so that transmission of the vibration to the projector 100 can be suppressed. A large amount of swing motion of the projected image light L and a decrease in the visibility thereof can therefore be suppressed.

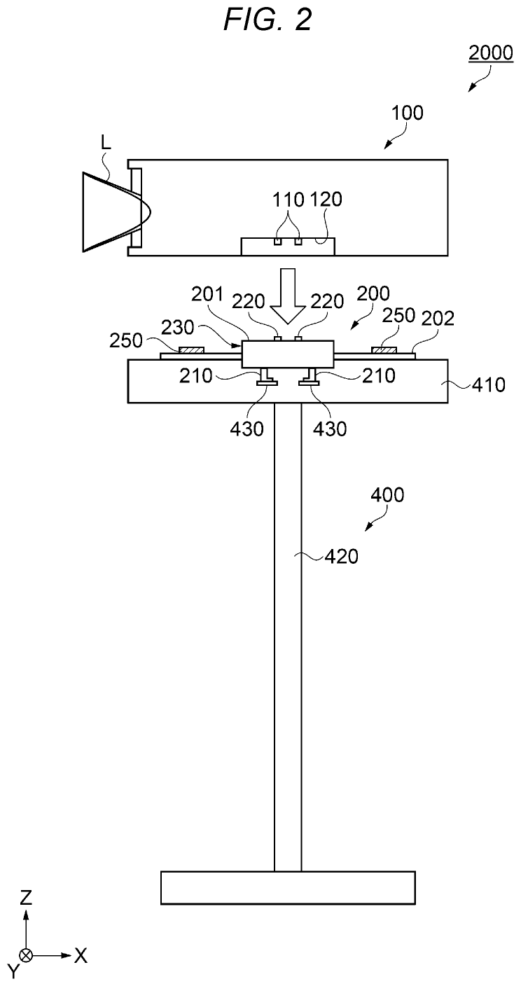

The configuration of a second projection unit 2000, which is another example of the projection unit, will next be described with reference to FIG. 2.

The second projection unit 2000 includes a stand 400, the projector 100 placed on the stand 400, and the adapter 200, which couples the stand 400 and the projector 100 to each other, as shown in FIG. 2.

The projector 100 of the second projection unit 2000 is installed on the stand 400, and projects the image light L from the upper side of the stand 400, for example, onto a screen. The projector 100 can be installed on the stand 400 by using the same adapter 200 as the adapter 200 used in the first projection unit 1000. That is, the adapter 200 can be used for both the first projection unit 1000 and the second projection unit 2000.

The stand 400 includes a placement table 410, on which the projector 100 is placed, and a leg 420, which supports the placement table 410, as well as the adapter 200. The placement table 410 includes electric contacts 430 as the power supplier electrically coupled to the first terminals 210 of the adapter 200. The placement table 410 and the adapter 200 may be collectively referred to as the placement table 410. The placement table 410 is not entirely necessary. The adapter 200 may be referred to as the placement table 410.

The projector 100 is installed on the stand 400 by coupling the adapter 200 to the placement table 410 and then coupling the second terminals 220 of the adapter 200 to the third terminals 110 of the projector 100.

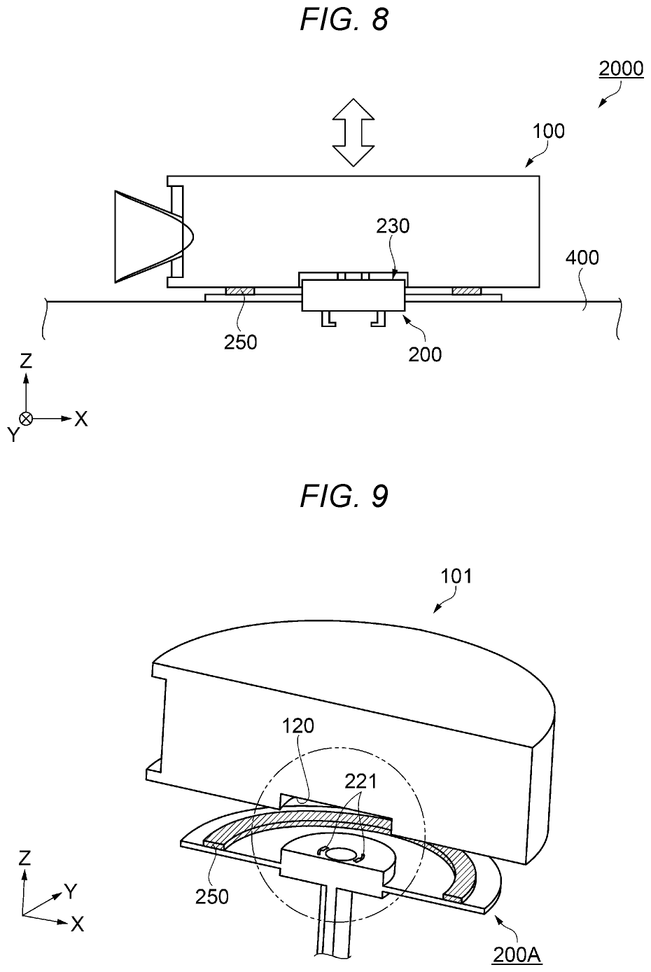

In the second projection unit 2000, in which the projector 100 is provided with the recess 120, and the adapter 200 is provided with the protrusion 230, the protrusion 230 of the adapter 200 can be fitted into the recess 120 of the projector 100, so that the projector 100 can be readily coupled to the adapter 200 (see FIG. 8) , as in the first projection unit 1000. That is, when the recess 120 couples the projector 100 to the adapter 200, the recess 120 has the function as an assistant guide that guides the two components to the coupling position.

The adapter 200 and the projector 100 are fixed to each other, for example, by using a fixing method using a screw structure or any other structure, as in the first projection unit 1000.

An elastic part 250 is disposed at the extension 202 of the adapter 200 at the side facing the projector 100, as described above. Since the elastic part 250 is disposed between the combination of the placement table 410 and the extension 202 of the adapter 200 and the projector 100 as described above, even when the placement table 410 vibrates or wobbles, the elastic part 250 can suppress the vibration, so that transmission of the vibration to the projector 100 can be suppressed. A large amount of swing motion of the projected image light L and a decrease in the visibility thereof can therefore be suppressed.

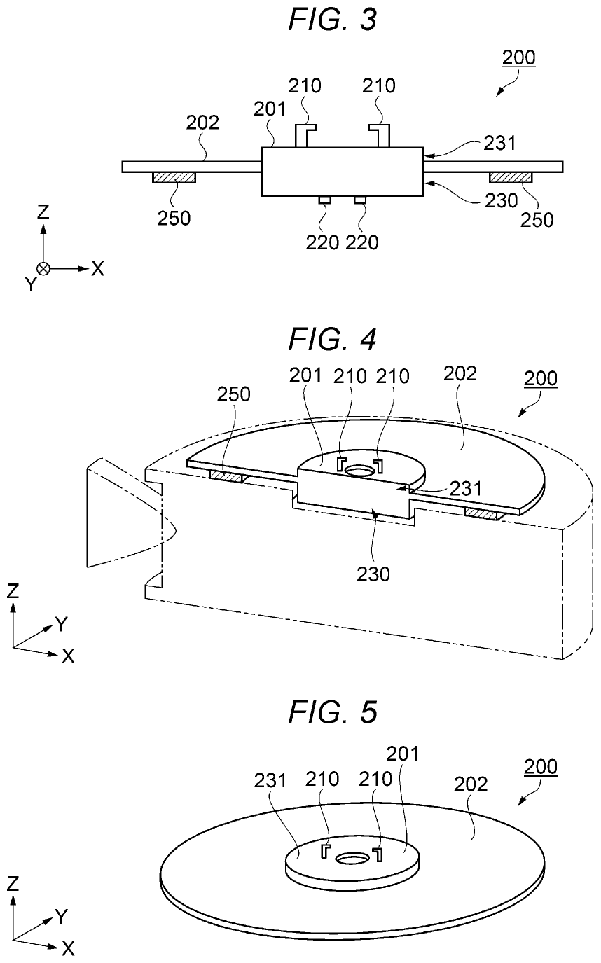

The configuration of the adapter 200 will next be described with reference to FIGS. 3, 4, 5, and 6.

The adapter 200 is formed, for example, in a substantially disc shape, as shown in FIGS. 3, 4, 5, and 6.

The central section 201 of the adapter 200 is thicker than the portion therearound. The central section 201 has the protrusion 230 described above. The second terminals 220 are provided at the protrusion 230.

The first terminals 210 are provided at a protrusion 231, which is a rear protrusion with respect to the protrusion 230, which is a front protrusion. The extension 202, which extends outward from the central section 201, is formed to cause the adapter 200 to come into contact with the projector 100 and the ceiling 300 or the stand 400 in a well-balanced and uniform manner.

The first terminals 210 are attachable to and detachable from the electric contacts 310 (see FIG. 1) provided at the ceiling 300 and the electric contacts 430 (see FIG. 2) provided at the stand 400, as described above. The second terminals 220 are used to supply the projector 100, which projects the image light L, with electricity via the first terminals 210, and coupled to the projector 100.

Since the adapter 200 includes the thus configured first terminals 210 and second terminals 220, attaching the first terminals 210 to the electric contacts 310 at the ceiling 300 allows the projector 100 to be placed at the ceiling 300 via the second terminals 220, or attaching the first terminals 210 to the electric contacts 430 of the stand 400 allows the projector 100 to be placed on the stand 400 via the second terminals 220. That is, using the adapter 200 including the first terminals 210 and the second terminals 220 allows an increase in flexibility of installation of the projector 100.

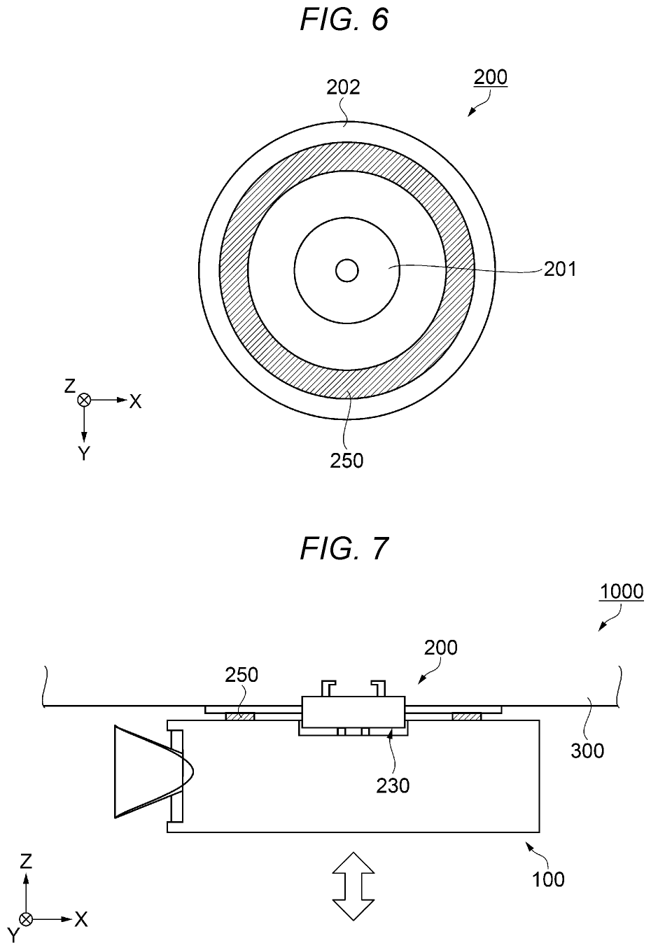

An elastic part 250 is disposed at the extension 202 of the adapter 200 at the side facing the protrusion 230, as described above. The elastic part 250 is formed in an annular shape along the outer circumferential edge of the extension 202, as shown in FIG. 6. It is preferable that the position where the elastic part 250 is disposed is set at an outer possible position on the extension 202 instead of an inner position. Since a wide range of the extension 202 is thus surrounded by the elastic part 250, variation in the height of the elastic part 250 or a warp of the ceiling 300 is likely to be canceled, so that a planar, stable elastic part 250 is achieved.

Since the elastic part 250 is disposed in an annular shape at the extension 202 as described above, the projector 100 and the adapter 200 can be brought into contact with each other via the elastic part 250. There is therefore no gap between the projector 100 and the adapter 200 in the portion where the two components sandwich the elastic part 250, so that transmission of the vibration to the projector 100 can be suppressed (see FIG. 8).

As described above, the stand 400 according to the present embodiment includes the placement table 410, on which the projector 100, which projects the image light L, is placed, the leg 420, which supports the placement table 410, the power supplier, which supplies the projector 100 with power for driving the projector 100, and the elastic part 250 disposed between the placement table 410 and the projector 100.

According to the configuration described above, in which the elastic part 250 is disposed between the placement table 410 and the projector 100, even when the placement table 410 vibrates, the elastic part 250 can suppress the vibration, so that transmission of the vibration to the projector 100 can be suppressed. A large amount of swing motion of the projected image light L and a decrease in the visibility thereof can therefore be suppressed.

It is preferable in the stand 400 according to the present embodiment that the placement table 410 is disposed to be attachable to and detachable from the leg 420 and the ceiling 300, and that the power supplier is disposed on the placement table 410. According to the configuration described above, power can be supplied to the projector 100 by the power supplier disposed on the placement table 410. Furthermore, the placement table 410 is attachable and detachable, and when the placement table 410, that is, the adapter 200 is installed at the ceiling hook on ceiling 300 in place of the stand 400, a large amount of swing motion of the image light L projected from the projector 100 installed at the ceiling 300 can be suppressed.

It is further preferable in the stand 400 according to the present embodiment that the power supplier is provided at the center of the placement table 410, that the placement table 410 includes the extension 202 extending from the power supplier along the installation surface of the projector 100, and that the elastic part 250 is disposed at the extension 202. According to the configuration described above, in which the elastic part 250 is disposed at the extension 202, the extension 202 can widen the range over which the elastic part 250 is in contact with the projector 100, so that the vibration can be further suppressed. That is, the projector 100 can be installed in a stable manner.

It is preferable in the stand 400 according to the present embodiment that the elastic part 250 is disposed along the outer circumferential edge of the extension 202.

According to the configuration described above, in which the elastic part 250 is disposed along the outer circumferential edge, the elastic part 250 can be brought into contact with the projector 100 over a wider range, so that the vibration of the projector 100 can be suppressed in a well-balanced manner.

It is preferable in the stand 400 according to the present embodiment that the placement table 410 and the projector 100 are in contact with each other via the elastic part 250. According to the configuration described above, in which the placement table 410 and the projector 100 are in contact with each other via the elastic part 250, there is no gap between the elastic part 250 and the projector 100 and between the elastic part 250 and the placement table 410, so that the vibration can be further suppressed.

It is preferable in the stand 400 according to the present embodiment that the enclosure 100a of the projector 100 is provided with the recess 120, that the placement table 410, that is, the adapter 200 includes the protrusion 230, at which the power supplier is disposed, that the projector 100 and the placement table 410 are electrically coupled to each other via the protrusion 230 fitted into the recess 120, and that the thickness of elastic part 250 is greater than the difference between the depth of the recess 120 and the height of the protrusion 230. According to the configuration described above, in which the elastic part 250 is thick, the projector 100 is always in contact with the elastic part 250, so that the projector 100 can be installed in a stable manner.

The adapter 200 according to the present embodiment includes the first terminals 210, which are attachable to and detachable from the electric contacts 310 provided at the ceiling 300 and the electric contacts 430 provided at the stand 400, the second terminals 220, which supply the projector 100, which projects the image light L, with power via the first terminals 210 and are coupled to the projector 100, the extension 202, which extends from the central section 201 along the installation surface of the projector 100, and the elastic part 250 disposed between the extension 202 and the projector 100.

According to the configuration described above, in which the elastic part 250 is disposed at the extension 202, even when the placement table 410 vibrates, the elastic part 250 can suppress the vibration, so that transmission of the vibration to the projector 100 can be suppressed. A large amount of swing motion of the projected image light L and a decrease in the visibility thereof can therefore be suppressed.

Variations of the embodiment described above will be described below.

As described above, the adapter 200 is not necessarily disposed at the stand 400 in a detachable manner, and the leg 420 of the stand 400 may be configured to have the function of the adapter 200. Specifically, for example, the placement table 410 supported by the leg 420 is provided with the second terminals 220. The configuration described above, in which the leg 420 includes the second terminals 220, also allows the projector 100 to be placed on the stand 400 without via the adapter 200.

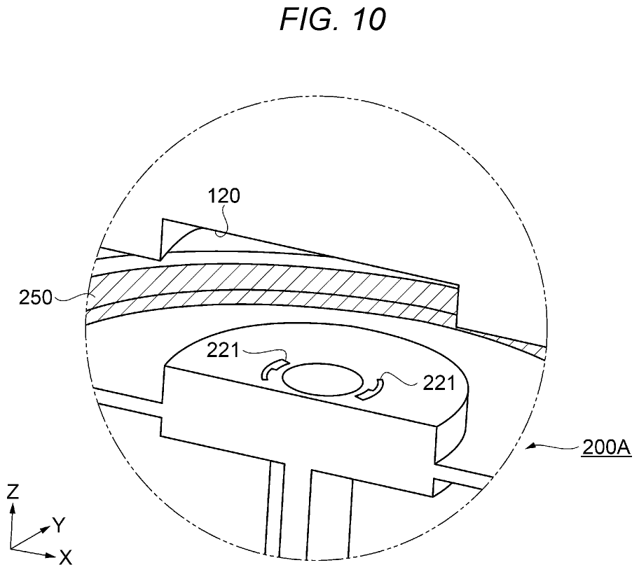

Unlike the configuration described above, the second terminals 220, which are provided at the adapter 200 and each have a protruding shape, and the third terminals 110, which are provided in the recess 120 of the projector 100 and each have a protruding shape, may not be in contact with each other for electrical coupling, but the configuration shown in FIGS. 9 and 10 may be employed.

Specifically, in an adapter 200A according to a variation, the portions corresponding to the second terminals 220 are recessed coupling terminals 221 for ceiling hook, as shown in FIGS. 9 and 10. On the other hand, the recess 120 of a projector 101 is provided with protruding coupling terminals for ceiling hook that are not shown. The configuration described above allows, for example, the adapter 200A and the projector 101 to be fixed to each other by using the ceiling hooks without fixing the two components to each other, for example, by using a screw structure.

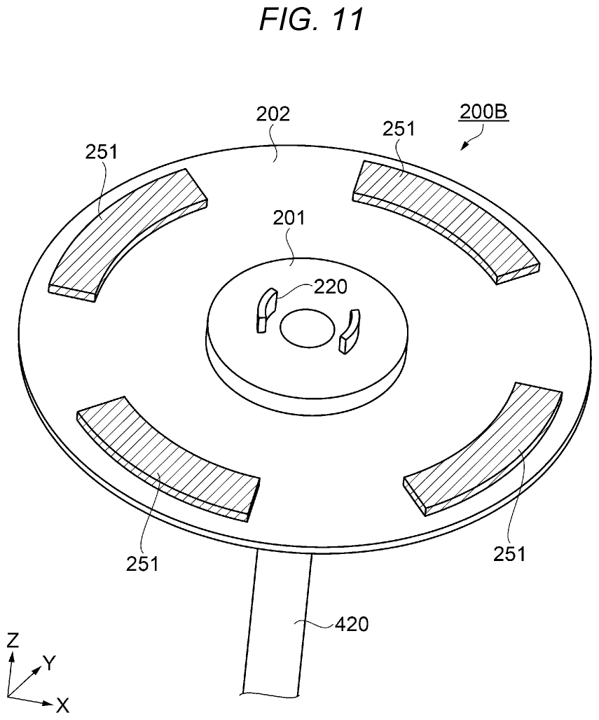

Unlike the arrangement described above, the annular elastic part 250 is not necessarily disposed, and the annular elastic part 250 may be divided into a plurality of members and arranged as shown in FIG. 11. Specifically, in an adapter 200B according to another variation, for example, the annular elastic part is divided into four members, and a gap is provided between each pair of adjacent elastic parts 251 and 251, as shown in FIG. 11. Also in this case, it is preferable that the positions where the elastic parts 251 are disposed are outer possible positions on the extension 202.

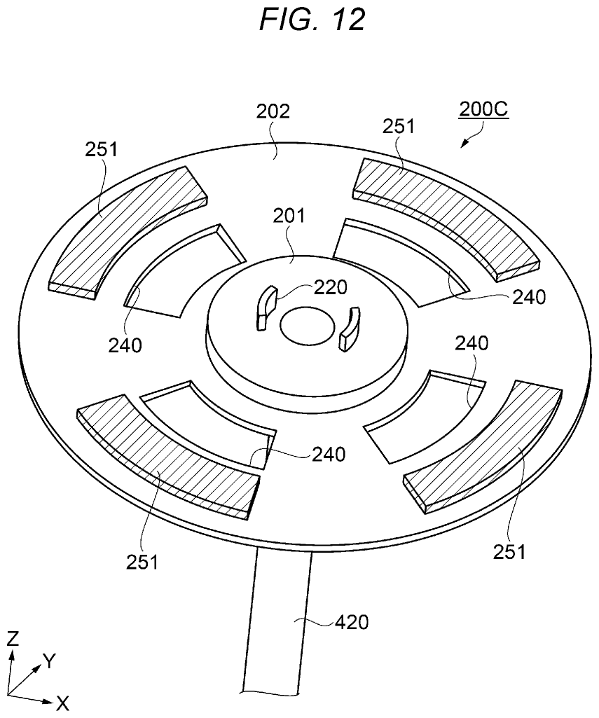

In the extension 202 of an adapter 200C, openings 240 may be formed inside the elastic parts 251, as shown in FIG. 12. Specifically, the enclosure 100a of the projector 100 is provided with intake ports that are not shown. The adapter 200C according to another variation is provided with the openings 240 at the positions corresponding to the intake ports in the state in which the projector 100 is coupled to the adapter 200C. Note that the placement table 410 is also provided with openings that are not shown at the same positions. The openings 240 may be provided at positions outside the elastic parts 251 depending on the positions of the intake ports.

The extension 202 of the adapter 200C and the placement table 410 therefore do not interfere with the air having sucked via the intake ports, so that the air can be smoothly sucked.

As described above, it is preferable in the adapter 200C and the placement table 410 according to the variation that the enclosure 100a of the projector 100 is provided with intake ports, and that the openings 240 are provided at the positions corresponding to the intake ports. According to the configuration described above, in which the openings 240 are provided, a decrease in the air intake capability of the projector 100 can be suppressed even when the projector 100 is caused to engage with the adapter 200C.

The opening holes 240 of the adapter 200C are not necessarily used to suck air, and may be used to prevent the extension 202 from blocking the light output from an illuminator that is not shown but is provided in the projector 100.

It is preferable in the adapter 200C according to the variation that the power supplier, such as the second terminals 220, is disposed inside the openings 240, and the elastic part 251 is disposed outside the openings 240. It is more preferable that the divided elastic parts 251 are arranged at equal intervals in the circumferential direction of the extension 202. According to the configuration described above, in which the elastic parts 251 are disposed at positions outside the opening 240 in the radial direction, the elastic parts 251 can be brought into contact with the projector 100 over a wide range, so that the projector 100 can be installed in a stable manner. Even when there is variation in the dimensions of the elastic parts 251 or a warp of the ceiling 300, the elastic parts 251 disposed at outer portions of the extension 202 can absorb the warp, so that the projector 100 can be kept horizontal.

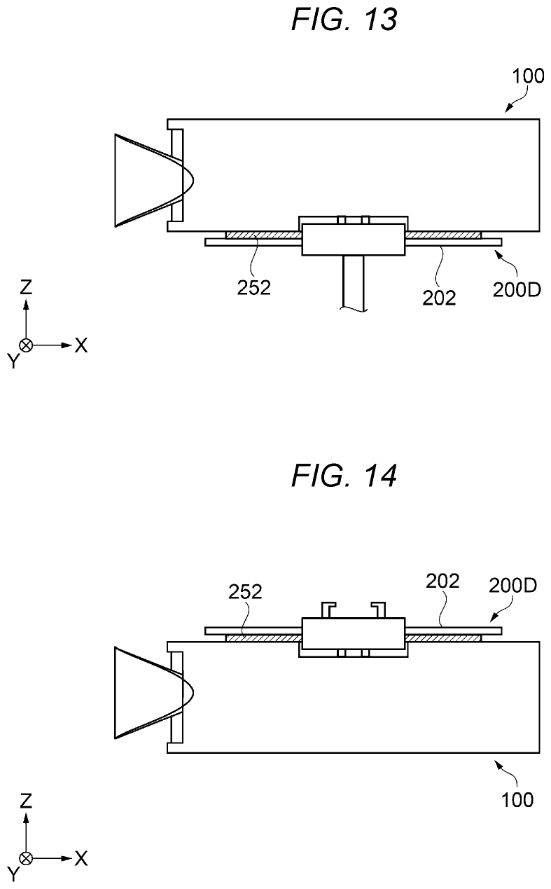

The annular elastic part 250 is not necessarily disposed at the extension 202 of the adapter 200, and a first elastic part 252 may be disposed so as to substantially cover the entire extension 202, as in an adapter 200D according to another variation shown in FIGS. 13 and 14. The area over which the first elastic part 252 is in contact with the projector 100 thus increases, and the gap between the extension 202 and the projector 100 is further reduced, so that transmission of the vibration from the placement table 410 to the projector 100 can be further suppressed.

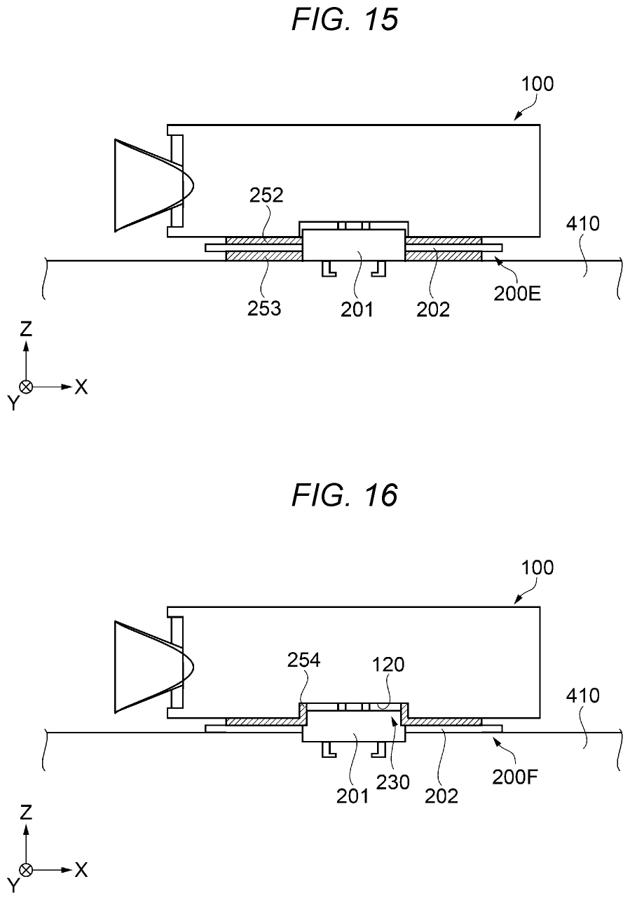

In addition to the first elastic part 252 disposed at the extension 202 of the adapter 200 at the side facing the projector 100, a second elastic part 253 may be disposed at the extension 202 at the side facing the placement table 410, as shown in FIG. 15. That is, the opposite sides of the extension 202 may be covered with the elastic parts 252 and 253.

The configuration described above allows suppression of the vibration between the adapter 200 and the stand 400 and between the adapter 200 and the ceiling 300 in addition to the vibration between the adapter 200 and the projector 100.

It is preferable in an adapter 200E according to another variation that the elastic part includes the first elastic part 252 disposed at the surface of the extension 202 at which the projector 100 is installed, and the second elastic part 253 disposed at the surface opposite from the surface at which the projector 100 is installed. The configuration described above, in which the elastic parts 252 and 253 are disposed at the opposite surfaces of the extension 202, can eliminate a gap between the stand 400 and the adapter 200E and a gap between the adapter 200E and the projector 100, so that transmission of the vibration of the placement table 410 to the projector 100 can be further suppressed.

An elastic part 254 may be disposed in the portion where the protrusion 230 of the adapter 200 is fitted into the recess 120 of the projector 100, in other words, between the side surface of the recess 120 and the side surface of the protrusion 230, as shown in FIG. 16. Horizontal movement of the adapter 200F and the projector 100 can thus be suppressed, so that transmission of vibration of the adapter 200F to the projector 100 can be suppressed.

Note that the recess 120 of the projector 100 and the protrusion 230 of the adapter 200 may or may not be in contact with each other except for the electric contacts. The recess 120 and the protrusion 230 may be threaded so that they are fixed to each other.

Unlike the configuration described above, the placement table 410 is not necessarily provided with the electric contacts 430, and the leg 420 may be provided with the electric contacts 430 when the placement table 410 is not provided.

What is claimed is:

1. A stand comprising:
a placement table on which a projector that projects image light is placed;
a leg that supports the placement table;
a power supplier that supplies the projector with power for driving the projector; and
a first elastic part disposed between the placement table and the projector.

2. The stand according to claim 1,
wherein the placement table is attachable to and detachable from the leg and a ceiling hook on a wall, and
the power supplier is disposed at the placement table.

3. The stand according to claim 1,
wherein the power supplier is provided at a center of the placement table,
the placement table has an extension extending from the power supplier along an installation surface of the projector, and
the first elastic part is disposed on the extension.

4. The stand according to claim 3,
wherein the first elastic part is disposed along an outer circumferential edge of the extension.

5. The stand according to claim 1,
wherein the placement table and the projector are in contact with each other via the first elastic part.

6. The stand according to claim 1,
wherein the placement table is provided with an opening disposed at a position corresponding to an intake port of the projector.

7. The stand according to claim 6,
wherein the power supplier is disposed at a position inside the opening, and
the first elastic part is disposed at a position outside the opening.

8. The stand according to claim 1, further comprises
a second elastic part disposed at a second surface of the placement table that is opposite from a first surface of the placement table at which the projector is placed,
wherein the first elastic part is disposed at the first surface.

9. The stand according to claim 1,
wherein an enclosure of the projector is provided with a recess,
the placement table has a protrusion at which the power supplier is disposed,
the projector and the placement table are electrically coupled to each other via the protrusion fitted into the recess, and
a thickness of the first elastic part is greater than a difference between a depth of the recess and a height of the protrusion.

10. An adapter comprising:
a first terminal attachable to and detachable from a first electric contact disposed on a wall, and a second electric contact disposed on a stand;
a second terminal coupled to a projector that projects image light;
a coupler at which the first terminal and the second terminal are disposed;
an extension extending from the coupler along an installation surface of an enclosure of the projector; and
an elastic part disposed between the extension and the projector,
wherein the second terminal supplies power via the first terminal to the projector.
